(19) United States
(12) Patent Application Publication
(10) Pub. No.: US 2003/0012344 A1
(43) Pub. Date: Jan. 16, 2003

(54) System and a method for emergency services

(76) Inventors: Rita Agarwal, Singapore (SG); Kapil K. Gupta, Singapore (SG)

Correspondence Address: MORRISON & FOERSTER LLP, 2000 PENNSYLVANIA AVE, NW, SUITE 5500, WASHINGTON, DC, 20006-1888, US

(21) Appl. No.: 09/901,145

(22) Filed: Jul. 10, 2001

(51) Int. Cl. H04M 11/04

(52) U.S. Cl. 379/37

(57) ABSTRACT

A system and a method for communicating information concerning required emergency services including a software Emergency Utility that may reside on any home, office, automobile or hand-held device, or internet website, that can, when activated, automatically communicate emergency information to emergency service facilities and to other desired persons or devices. A ubiquitous Emergency icon is also provided for the activation of the Emergency utility.

### BACKGROUND OF THE INVENTION

1. Field of the Invention

This invention relates to systems and methods for alerting emergency services and personnel of emergency situations. In particular, this invention relates to a software Emergency Utility that may reside on any home, office, automobile or hand-held device, or internet website, that can, when activated, automatically communicate emergency information to emergency service facilities and to other desired persons or devices. This invention also relates to a ubiquitous Emergency icon for the activation of the Emergency utility.

2. Description of the Prior Art

The most commonly employed method to request emergency medical, police or firefighting services is to place a voice call to an Emergency Response Center, also known as Public Safety Answering Point (PSAP), by dialing a specified emergency phone number (911 in the U.S.), and then explaining the emergency to the person who answers the phone. Emergency phone numbers vary from region to region and country to country.

In the U.S. there are about 4300 Emergency Response Centers that respond to 911 emergency calls. Some Emergency Response Centers are also equipped with teletype (TTY) devices in order to communicate with persons with certain disabilities. However, TTY equipment still utilizes voice telephone lines and still requires the user to type out details concerning the emergency situation.

Based on the circumstances described by the caller, appropriate emergency services are dispatched to the location where they are needed. According to this system, it is hoped that the necessary emergency services are made available to the calling party in as short a time as possible, as most situations require an immediate response and action in potentially life threatening situations. However, having to explain the emergency situation to emergency response personnel over voice communication lines, either land-based telephones or mobile phones, has to-date remained the only way to access emergency services.

The prior art system of requesting emergency services has a number of disadvantages. A person may not always have access to a voice communication line, or the person calling for emergency services may not know the appropriate number to call for emergency service. Sometime a person in need of emergency service may not be able to call for emergency service (911 or some other number) and/or communicate verbally with the emergency operator. This can happen when the person is far away from the phone and can not reach it, for example, as a result of an injury or a disability, or if the person is experiencing a medical condition such as heart attack, that disables the speech capability. In some emergencies, the person requesting emergency services may not have time to call for reasons because of a fire, an intruder, or other situations in which talking on the phone may be life threatening. Also a person may not know the codes to dial from the place they are located to access the emergency services, for example, from a hotel room.

Further, the current method of contacting and transmitting information to Emergency Response Centers can be too complicated for children who may need to call for emergency services. Often times callers to Emergency Response Centers are unable to quickly give all the necessary information. For example, it may be difficult to describe the location of the emergency; the person making the call may not know or have at their disposal specific information concerning the party in need of emergency assistance (visitor, babysitter, relatives, friends and so on); there may be language problems as the calling person and the emergency operator may speak different languages; or the calling person (such as a child, speech and/or hearing impaired) may not know how to communicate with the emergency operator.

In addition, in many instances, conveying the necessary information can take up precious time, and the conveyed information may be incomplete, incorrect, or misunderstood. The current method also does not have an efficient method for contacting other parties, for example, relatives, friends, neighbors, neighborhood watch program participants, lawyers, employers, doctors and so on) who need to be informed of the emergency situation.

The current methods of alerting relevant parties of emergency situations are also inadequate. For example, there may be a fire in a building, the alarm may have been turned on, and the building may have to be evacuated immediately. Existing systems for informing the relevant parties of such an emergency situations may not adequately alert everyone, for example, the fire and/or emergency alarm may not be heard by everyone, and/or escape routes and/or other important information required for immediate and appropriate response to the emergency situation may not be familiar to everyone.

### SUMMARY OF THE INVENTION

The present invention provides a one-click solution for the problems and disadvantages of the prior art methods for alerting the proper authorities and services of emergencies. The invention may be used to instantly and automatically provide critical information to emergency services, including the nature of emergency, the address and location of the emergency, directions to the emergency (including shortcuts, and alternate routes), and the layout, floor plan and/or blueprint of the house, building or other facility where the emergency is taking place. An emergency management system can be initiated by clicking on the Emergency Icon on a computing device.

This invention is ideally suited for use in the home, at work, in automobiles, in hotels, in schools and daycare centers, and in other public areas, for example, in malls, parking lots, and stadiums.

The invention comprises an Emergency Utility (EU) resident on a computing device, and an Emergency Icon (EI) on the screen or display of the computing device. Preferably, the Emergency Icon is strategically placed, has a distinct size, color and shape, and is displayed prominently at all times.

A computing device is a device that has memory and a microprocessor sufficient for running the Emergency Utility of this invention. Preferable computing devices include, PCs, whether home or office, stand-alone, networked (by LAN or WAN) or connected to the internet (including broadband wired and wireless access), laptops, handheld PDAs, Web-TV, set-top boxes, cash registers, intelligent appliances, multiple computing devices that share the same resources (MPCs); computing devices where the computing resources are located at a remote location (RPCs), wearable computers, residential gateways and web sites. Other preferable computing devices include mobile phones, web-pads, pagers or other such devices.

According to a preferred embodiment, the Emergency Utility will be executable in any operating system (OS) environment, for example, Windows family of OS, Linux, Unix, Palm-OS, Macintosh-OS, micro browsers, Mobile-OS.

The Emergency Utility includes an emergency management system response file that contains all the information necessary for prompt and efficient response to emergencies, including the address and location of the emergency, directions to the emergency, including shortcuts and alternate routes, and the layout, floor plan and/or blueprint of the house, building or other facility where the emergency is taking place. Preferably, the emergency response file also includes the names, ages, and medical information and history of persons likely to be at the site of the emergency. Preferable medical information can include, for example, known allergies, handicaps, disability, and organ donation information. The emergency response file may also include emergency contact information, for example, names, phone numbers, street addresses and e-mail addresses of neighbors, friends and family. The emergency response file can also contain passwords for obtaining confidential information about the user from web sites or other computer systems.

According to one embodiment of the invention, the emergency response file may also include a database of important personal and financial information, who to contact in case of an emergency, insurance information (health, house, life, car, belongings etc), bank account and other financial information, businesses, wills; identification of preferred lawyer(s), doctor(s), accountant(s), religious information and even desired burial arrangements.

Once activated, the Emergency Utility contacts the local emergency response center, alerts it to the existence of an emergency, and automatically uploads the emergency management system response file to the emergency response center's computer system.

In another embodiment of the present invention, one may designate certain fixed hardware area and/or certain files and folders in a fixed location of the computing device for storing emergency related information. The information stored there could be made available to emergency service providers and they may have access to it, once authorized. This access could be remote, and the internet may be used to electronically access information that resides in one's computing system.

Alternatively, the Emergency Utility may direct the emergency response center to a website that contains all the necessary and important emergency response information. According to this embodiment, the emergency response center is alerted to the web site (or it is self alerted) at which useful information may be found for the emergency situation. The contents of the web site may be prepared in multiple languages. The password-protected information can be accessed once the password information is delivered via the file, verbally, SMS (or its equivalent), or other suitable means. Other secure means for communication of password and other confidential information are known to those of ordinary skill in the art and can be used with the current invention.

The Emergency Utility may also automatically initiate a chat session with the 911 emergency response center to communicate the nature of the emergency and seek assistance. Such sessions may also be opened to communicate with other persons (family, friends, lawyer, people dispatched to help and so on).

A camera can be utilized as part of this invention to provide additional information to an emergency response center. For example, activation of the Emergency Utility can cause closed-circuit television or video images to be broadcasted to the emergency response center. In addition to broadcasting these images, or instead of broadcasting these images the Emergency Utility can cause the camera to record the emergency situation save the video data until needed.

The Emergency Utility can also be used to quickly notify others parties of the emergency situation. For example, the Emergency Utility can automatically contact other computing systems, for example, those of neighbors, family members, insurance companies, etc., alerting them of the emergency and uploading important information to their computer systems. The Emergency Utility can also contact other parties using prewritten emails that are automatically sent to intended parties upon activation of the Emergency Icon. The Emergency Utility can also be configured to automatically contact services that place pre-recorded voice calls (for example, using internet telephony), and/or send faxes. According to a preferred embodiment of the invention, the Emergency Utility may repeatedly send the emergency notification including the file and the emails until it receives an acknowledgment that help is on the way. This may be accomplished in a certain manner that could either be pre-programmed, set to a default, or decided at the moment.

In yet another embodiment, instead of, or in addition to, the Emergency Utility contacting third parties, the emergency response center may be instructed or requested to send certain emails as required for the handling of the emergency situations. They could be to friends, family, neighbors, work-place, doctors, insurance, etc (their contact information being available in the emergency management system response file) as well as law enforcement, and other entities.

According to a further embodiment, the present invention may include communication of information, initially communicated to the emergency response center, to other persons. For example, the present invention includes the electronic communication of information from the emergency response center to emergency service vehicles (ambulance, police cars, fire-trucks, etc) in order to plan and prepare for emergency responses, revise response strategies as appropriate during an ongoing response. In addition, the present invention includes electronic communication from emergency response vehicles back to the emergency response center to provide updates concerning ongoing or completed emergency responses, or to request additional information necessary for effective emergency response.

According to the present invention, the Emergency Utility may also electronically contact other government and non-government organizations that provide medical and security related services (emergency or otherwise) on a registration and/or non-registration basis. Such organizations may include services that call in to check if everything is all right if a security alarm is tripped for home and other security applications. Such organizations may also include companies that provide services to elderly and sick persons whereby, according to the prior art, the persons were required to reach the company's operator when they were in need of assistance. According to the present invention, when the services are required, the the need for assistance, and the information necessary to render assistance, is communicated electronically.

If needed, the Emergency Utility can be configured to automatically inform the local phone company to forward calls to a new number. It can also forward received emails to a new destination. It will also access, collate, and store the information that customized collation services provide at pre-programmed intervals.

The invention may also be used for other emergency situations such as an emergency in the neighborhood. In such situations, one may have more time to respond. The overall solution may be customized with or without a standard telephone system. The Emergency Icon may include sub-icons for personal and other (neighbors, friends) emergencies. In the latter case, the Emergency Utility may have more limited information concerning the emergency, or the person or family in need of assistance, but this information could still be communicated more effectively according to the invention using the internet and other electronic technologies described herein. In yet another embodiment, it is possible to use the present invention to initiate emergency response procedures from far away locations using the present invention. For example, if a person becomes aware of an emergency in connection with an elderly parent or a child in a remote location, the Emergency Utility may be configured to intiate emergency response procedures for the parent or the child by contacting the emergency response center nearest the parent or child and providing the emergency response center with information necessary for assistance to the parent or child.

The present invention could be further utilized in many other situations when one needs to reach out for assistance. Such situations include non-life threatening medical emergencies. According to the invention, local authorities (hospitals, police, neighborhood watch, fire department, and so on) could be reached directly in an electronic manner and asked to provide assistance. These local authorities will now have more timely and complete information that may lead to their providing far superior, effective, and efficient services. All such uses of the system and the method described here are included in the spirit and scope of the invention.

For emergencies of a non-personal nature, such as community emergencies—fire, forest fires, prison escapes, bombs, floods, earthquakes, tornadoes etc—the invention includes (a) setting up of a web-site on the internet that may be used by the publice to access information, (b) informing the radio, news-media (print or electronic) and TV stations, internet service providers, mobile service providers and certain popularly accessed web-sites (Yahoo, MSN, AOL, etc), and (c) inform others via email and SMS. The radio, TV and other media will also display prominently the URL of the web-site that the carries further information about the emergency situation. In a preferred embodiment, the URL of the web-site is of the form www.most-common-domain-name.com/911 or www.911.most-common-domain-name.com and it may carry information about all the emergencies for the region from where the web-site is accessible.

In addition to sending information to appropriate parties when activated by an end user, the Emergency Utility can also be configured to provide information to the end user. For example, the Emergency Utility may be configured to provide escape routes and emergency and/or evacuation procedures. The utility may also be configured to cause the sounding of alarms in the house, building or facility that is the site of the emergency.

The utility will also manage the response from the 911 center. It may download certain information from the 911 center or some other web site; and receive, process, and display information (files, emails etc) from the 911 center. This will make internet-based emergency response and help available to the calling person immediately. The utility could also contact services that place voice calls (for example, using internet telephony), and send faxes.

The present invention also provides for complete privacy for exchange of information from emergency utility executed by the person initiating the contact to the Emergency Response Center and the Emergency Response Center. This is done using encryption technology for encryption of the information before it is exchanged. A person may encrypt the entire emergency management response file or certain selected parts of it. In a preferred embodiment, the Emergency Response Center makes its public keys for encryption available to the public. Any information that is to be sent to the Emergency Response Center may be encrypted using its public keys. These public keys may be common to all the Emergency Response Centers of a region/country. Thus only the authorized personnel associated with the emergency management system (Emergency Response Center, law-enforcement etc) have access to this information. Passwords and other sensitive information can be protected using this method, thereby providing complete privacy and security to the user.

As an alternate embodiment or in addition to performing all the other tasks as described in this invention, the emergency utility (when executed by the emergency icon) may also access the web-site of the emergency response center. It will fill out the necessary description required to access the emergency services (name, location, nature of emergency, other pertinent information such as Emergency Response File, passwords, and so on) at the web-site, and further open a voice call and/or chat session and/or instant messaging session to communicate with the emergency response center's personnel, persons who respond to the emergency situation and others. The URL of the web-site of the emergency response center is stored in the emergency utility and the user initiating the contact with the emergency response center need not be informed of it.

The Emergency Utility may create and maintain a complete log of the events and all the information exchange that takes place due to the occurrence of the emergency situation. The Emergency Utility may also backup all files.

According to a preferred embodiment of the invention, the Emergency Utility may include electronic training manuals and software for interactive training sessions and emergency drills configured for use by children and/or adults. The Emergency Utility may also include a drill mode that interacts with building security and/or fire alarm systems. According to this embodiment, when a fire drill occurs, for example, the drill mode of the Emergency Utility is activated, and performs some or all of the emergency functions of the system in drill mode, including, for example, sending drill notifications to the emergency response center, and to other persons and entities that the system has been configured to notified, and displaying escape routes and other emergency response information to the user.

### DESCRIPTION OF THE DRAWINGS

FIG. 1 shows the various elements of the invention and the communication links between them.

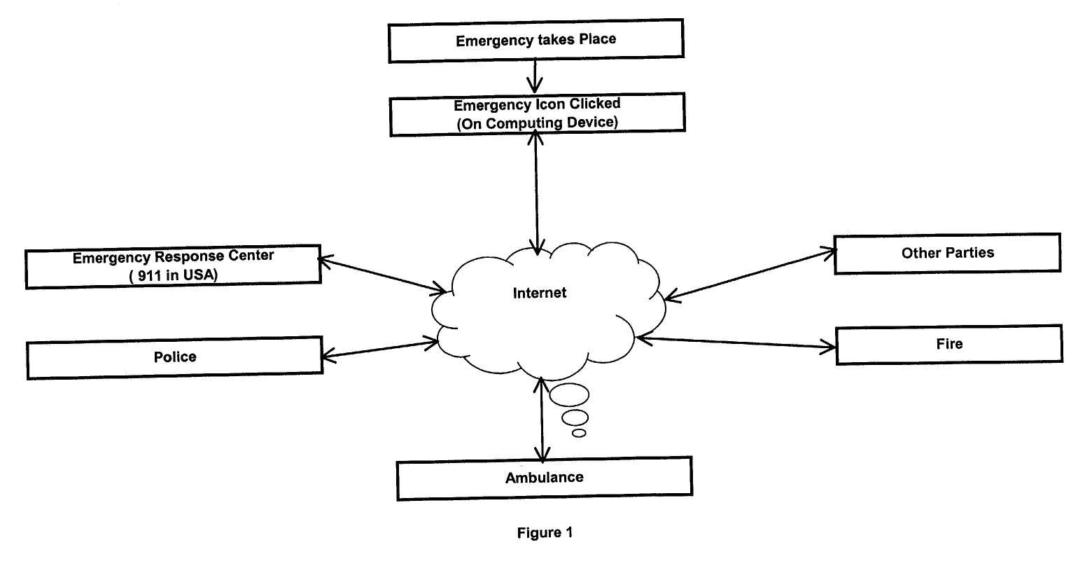

FIG. 2 shows a flow chart of the preferred embodiment of the invention from the perspective of the person initiating access to emergency services.

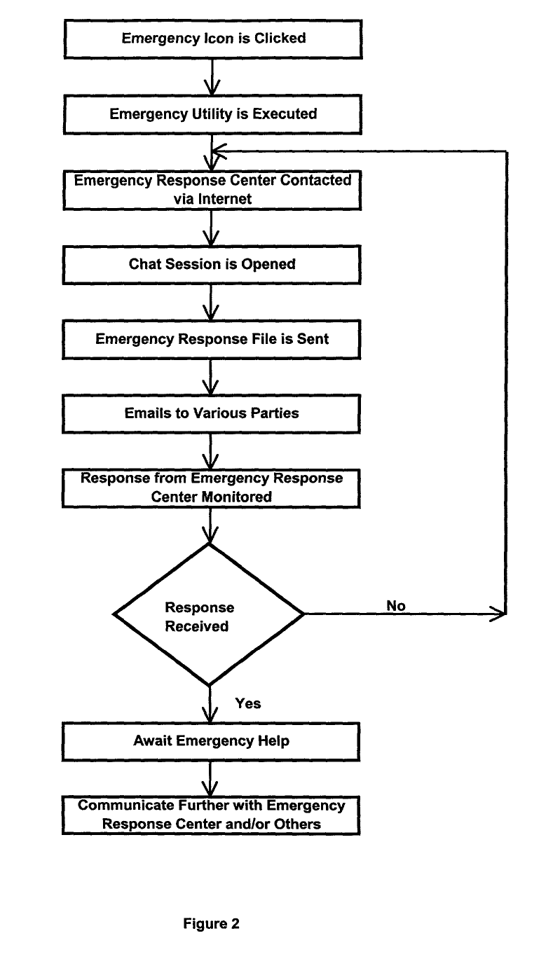

FIG. 3 shows a flow chart of the preferred embodiment of the invention from the perspective of the emergency services providers.

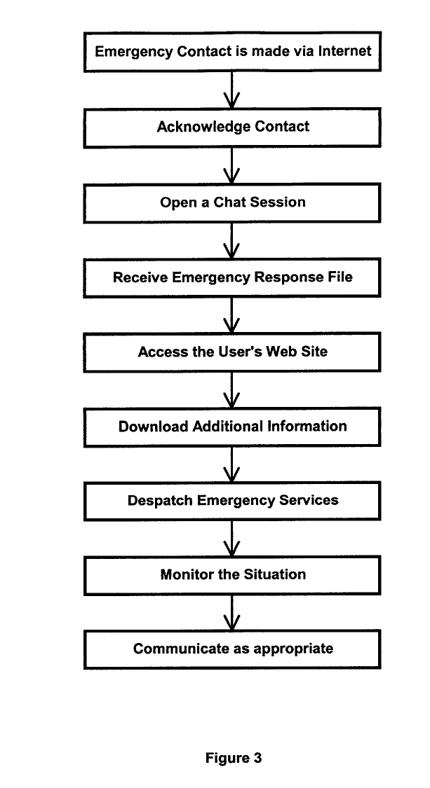

### DETAILED DESCRIPTION OF THE PREFERRED EMBODIMENTS OF THE INVENTION

An Emergency Utility is loaded onto a computing device. Many automobiles are equipped with computing devices, for example cellular phones, that are used in cases of accidents, auto-theft or attempt thereof. These devices may be programmed to contain the Emergency Utility or they may remotely execute the utility on a home computer.

An Emergency Icon is located on the screen or display of the computing device. Clicking the Emergency Icon causes the Emergency Utility to execute. Alternatively, or in addition to Emergency Icons, a keyboard and/or a mouse and/or a monitor and/or other places on the computing device may be provided with a button that can initiate the execution of the Emergency Utility. Preferably, buttons that can initiate the execution of the Emergency Utility on the computing device are placed strategically around the premises (house, workplace). According to a further embodiment of the invention, a button for initiating execution of the Emergency Utility is provided on a wearable band, pendant, or other personal ornament.

Emergency Icon(s) can also be incorporated into one or more programs running on the computing device at any given time, for example, Internet Explorer, Microsoft Office etc. Emergency Icon(s) can also be provided on web sites that a person may have registered with and/or visits frequently, for example, MSN, AOL, CNN, YAHOO, LYCOS, or ALTAVISTA.

According to a preferred embodiment of the invention, the Emergency Icon is visible, and the Emergency Utility executable, at all times, including those times when the computing device is in a power save mode. If the monitor is touch sensitive, then the icon and the associated utility may be executed by touch.

When an emergency situation arises, a person may click the Emergency Icon on the computing device they are using, or in the application he or she is using, or on the website they are visiting. Alternatively, the person may press an activation button in the home, office, automobile, or other convenient location, or even activate the Emergency Utility by voice command.

Preferably, the utility can also be executed remotely. For example, someone can activate the Emergency Utility in their house by depressing buttons placed around the house, by using a computer device outside the house connected to the internet, by using a standard phone or mobile phones, etc.

According to one embodiment, the Emergency Utility can be executed by an automobile when its system detects an emergency situation. According to a further embodiment, the Emergency Utility may be automatically executed when a wearable computing device detects a serious medical condition, for example a heart attack, or excessive bleeding.

According to another embodiment, sensors in an office building or home, for example smoke sensors, motions sensors etc, automatically execute the Emergency Utility without user intervention.

Once the Emergency Utility has been activated, the Emergency Utility contacts the local emergency response center and automatically uploads an emergency management system response file to the emergency response center's computer system. If the system is activated without a user's intervention, the system also alerts the system's user of the emergency. The Emergency Utility may also contact other computing systems, for example those maintained by family, friends, neighbors, doctors, lawyers, accountants and insurance agents, and can automatically upload important information to those systems as well.

During the course of an emergency, information from the Emergency Response Center can continually be provided to a user updating them on the response of personnel to their emergency. In addition, preferably, the Emergency Response Center can continuously receive information from the user including any changes in the status of the emergency.

The information in the emergency management response file can be of sensitive nature and will depend on the user(s). It may also depend on the location, time, language, country, and other parameters programmed into the utility. The emergency management system response file may be prepared in multiple languages to ensure that the emergency services are available no matter which language is used to access them. Preferably, the sensitive parts of emergency management response file is stored and/or transmitted in an encrypted manner to protect the user's privacy.

Preferably, some or all of the information in the emergency management response file can be printed or provided to a user independent of the computing device. This information can then be continuously carried by the user and provided to emergency personnel when required.

According to an alternative embodiment of the invention, a unique URL (uniform resource locator) may be assigned to every phone number. When the emergency response center receives a telephone call, it can automatically access the web site of the URL that corresponds to the phone number of the incoming call. According to this embodiment, this web site contains pertinent information about the persons who use the phone number. Preferably, part or whole of this information is password protected.

Preferred embodiments are URLs of the type www.most-common-domain-name.com/ph.no.. The advantage of these URLs is that the phone number that is used to place the emergency call is automatically recognized at the emergency response center using the caller ID function and, therefore, the information on the web site can also be automatically displayed there. Alternate embodiments are also possible and are included in the spirit of the invention. An instance of alternate embodiments are URLs of the type www.ph.no.most-common-domain-name.com.

According to a further embodiment of the invention, the Emergency Utility may initiate a chat (audio, text, video, multi-media) session with the 911 emergency response center to communicate the nature of the emergency and seek assistance. Such sessions can also be opened to communicate with other persons for example, family, friends, personal lawyers, persons dispatched to assist in the emergency and so on. The Emergency Utility can include translation software for providing voice and text translations of information sent and received.

In one embodiment, the Emergency Utility can also cause the computing device to create the effect of police presence (siren, lights if possible) on the premises. This can be used to scare an intruder or a potential or a suspected intruder. It can also be programmed to generate audio and/or visual signals of a special nature to attract the attention of people in the vicinity of the emergency situation.

If a camera and microphone are connected to the computing system, then they can be used to record the emergency situation and communicate video information. The recording can be used later as evidence also.

Pre-written emails containing information pertinent to the emergency situation can be stored in the emergency response file and can be forwarded to the intended parties by the utility. Such emails may be multi-media, multi-language emails with attachments. The system may be programmed to send some of the emails after a certain delay, provided they are not retracted. The utility can also send emails with update information once the emergency situation is resolved. These emails can be to friends and family to put them at ease. These emails may also deal with claims information, payments, information to the regular doctor, and so on.

The Emergency Utility may also be configured to contact services that place voice calls (for example, using internet telephony), and send faxes.

Preferably, if the person is executing the utility using the network at a public place (airport, internet café etc), the system knows the exact location and it can communicate additional information to the emergency response center and other parties to facilitate the service.

Not all parts of the system and method of this invention may be available at all times as different parts require accessibility to different computing environments. For example, if the computing system is a stand alone one, it may only provide information and guidance to the person seeking emergency assistance. This will help the caller to communicate more effectively with the 911 operator. Therefore, even if a 911 phone call is made, the utility can still be used with or without internet components in getting emergency assistance.

According to further embodiments of the invention, the Emergency Utility can present further information and/or instructions to the person executing the utility. Several options that will help further in the emergency situation can also be presented to the user, for example, options to shut down or disable the system; convert into an internet phone and dial 911; and/or open a chat session.

For computing devices that are connected via a LAN or for computing devices that share resources, any emergency initiated by one computing device, may put all the other computing devices into an emergency mode that may involve display of this mode, and other crucial steps.

For computing devices where the computing resources are located at a remote location, the computing device will also communicate with the remote location in addition to the other functions that it performs in emergency situation. Additional functions may be incorporated depending on the environment in which remote computing is employed. For example, all computing devices on the same floor of a building that share the remote computing resources can also be alerted.

As an alternative embodiment of the present invention, the utility when executed may transform the computing system into a phone and call the emergency response center automatically.

The Emergency Utility that is executed on the computing device may perform many other functions depending on different environments. Some of these environments and appropriate functions are as follows:

For schools, offices and secured residential complexes, one may be executing the utility or responding to it when someone else executes it. The Emergency Utility will inform the authorities and security, display easily accessed escape routes, inform others in the immediate vicinity or beyond of the emergency electronically, audio and/or via a display on their monitors, inform the system operator or some other central location electronically, and respond to the emergency initiated by others. The system can be activated by the conventional means of initiating an emergency, for example a button on wall, which is linked to the system invented here electronically. The computer system at the work place can also automatically back-up all the work, files etc. in such emergency situations. A database may also be implemented that stores information on the employees, and in the case of schools, students, that may be needed in emergency situations.

The authorities can also use utilize the utility or information from the utility to inform parents or other guardians via emails, mobile phone, SMS, or some other means of particular school emergencies. The latest updates of the emergency situation may be put on the internet by the utility. Similar procedures can be built into the utility that handles emergency events for other places such as the stadiums, auditoriums, parks etc.

For hotels, in addition to the steps taken in personal emergency situations, the utility can inform the guests and/or hotel about the emergency situation. It will display escape routes, and provide other pertinent information.

For mobile devices, the Emergency Utility can be configured to initiate a call, use a short message service or utilize other means to communicate an emergency. The mobile device may further trigger Emails and transfer of system response file. If the system is equipped with the capability to determine location, then the utility will automatically include the location information in the information communicated.

For automobiles, any service that can determine location (E911, GPS etc.) can be combined with the computing or similar device (that may also be a part of the automobile itself) to communicate with the emergency response center. For travel by automobiles and airplanes, the system can include information such as the medication on board and how it may be retrieved. As soon as a person goes to a new location, the communication system (be it a wireless system such as the GSM or wireless local area network, or a local area network or some other equivalent system), can automatically update the person (including his equipment) with emergency information related to the situation.

According to a preferred embodiment of the invention, all information (icons, text, conversation etc.) can be speech enabled. Text-to-speech and speech-to-text systems may also be used to facilitate the emergency procedures.

Even when a phone call can be placed to the emergency operator, the system can still help in many ways, for example, the information can be read over the phone from the emergency utility on the computer.

As a part of the process of registration for travel and entertainment services (for example, cruises, air-travel, train travel, hotels, camping grounds, amusement parks), the computing devices of the person and the establishment can exchange information that is used in emergency situations. For example, the computing device of person can communicate medical information to the computing system of the cruise operator to use if an emergency occurs during the cruise. The computing system of amusement park operator can inform the computing device of the person's critical phone numbers to call in case an emergency arises on the park premises.

The present invention also provides a method for circumventing jamming that is often done locally to make a certain space free of mobile device usage. In areas where jamming occurs, it is not possible according to the present state of the art to place a 911 call using a mobile device. The present invention presents a solution to this problem whereby the entity employing jamming could provide for alternate means for wireless connectivity with a short range wireless system. According to this solution, when a person enters a jammed zone, she registers her mobile device with the jamming entity and further requests her mobile service provider to forward all calls for the said mobile device to a number provided by the jamming entity. The jamming entity now provides wireless connectivity to the registered persons and may forward the calls to them. This can be done manually, for instance, by bringing a cordless phone to them, or electronically by forwarding the calls back to their mobile phone using the short range wireless system, or by forwarding the calls to a special phone that operates on the short range wireless system provided by the jamming entity. For a dual mode mobile phone (one mode for cellular telephony and second for short-range wireless system), the user switches the mode of the phone. The jamming entity could control the calls by jamming the cellular system and controlling the calls on the short-range wireless system. This embodiment also enables one to make outgoing calls including the 911 calls by using the short-range wireless system.

Having now fully described this invention, it will be appreciated by those skilled in the art that the invention can be performed within a wide range of parameters within what is claimed, without departing from the spirit and scope of the invention.

We claim:

1. A method for transmitting to a service provider, information that may be useful for providing a service, comprising:
running a service response software program that resides on a computing device, said service response software program performing the following steps:
contacting a computing device maintained by the service provider and requesting service,
transmitting to said computing device maintained by the service provider information relating to the requested service.

2. A method according to claim 1 wherein the requested service is an emergency service, and the service provider is an emergency response center.

3. A method according to claim 1 wherein said contacting and transmitting steps are initiated by clicking an icon on a display of the computing device.

4. A method according to claim 1 wherein said contacting and transmitting steps are initiated by pressing a wireless button.

5. A method according to claim 1 wherein said contacting and transmitting steps are repeated until the computing device receives an acknowledgment from the computing device maintained by the service provider.

6. A method according to claim 1 wherein the information relating to said requested service comprises an address at which said requested service is desired.

7. A method according to claim 6 wherein the information relating to said requested service comprises names and ages of persons that are likely to be at the address at which said requested service is desired.

8. A method according to claim 1 wherein the information relating to said requested service comprises a URL for a website that contains further information relating to said requested service.

9. A method according to claim 1 wherein service is requested at a location that is different from the location of said computing device.

10. A method according to claim 1 wherein said service response software program causes e-mails to be sent to predetermined persons.

11. A method according to claim 1 wherein said service response software program requests said service provider to contact predetermined persons.

12. A method according to claim 1 wherein said service response software program displays information relating to said requested service on a display of said computing device.

13. A method according to claim 2 wherein said service response software program displays emergency response information on a display of said computing device.

14. A method according to claim 1 wherein said service response software program initiates an online chat session with said service provider.

15. A method according to claim 1 wherein said service response software program causes a camera to record images within its range of view.

16. A method according to claim 15 wherein said images are transmitted to said service provider.

17. A method according to claim 1 wherein said contacting and transmitting steps are automatically intiated by a sensing device.

18. A method according to claim 17 wherein said sensing device is a wearable device that monitors a physical state of a wearer.

19. A method according to claim 17 wherein said sensing device is a smoke detector.

20. A method according to claim 17 wherein said sensing device is a security device.

21. A method according to claim 1 wherein said service response software program contacts a website of said service provider and fills out an on-line form with information relating to said requested service.

22. A method according to claim 8 wherein said URL comprises a phone number corresonding to the location of said computing device and which may be identified by said service provider using caller ID.

23. A method for providing wireless communication in a region where jamming occurs comprising:
providing a registration system for wireless device users that enter the region where jamming occurs;
providing an alternate method of wireless communication to users that register with said registration system;
forwarding communications intended for said wireless device to said users using said alternate method of wireless communication.

24. A method according to claim 23 wherein said alternate method is a short range wireless system.

25. A method according to claim 24 wherein said wireless device has short range wireless capability.

26. A method according to claim 24 wherein a short range wireless device is provided to said user.
